(19) United States
(12) Patent Application Publication
(10) Pub. No.: US 2024/0113319 A1
(43) Pub. Date: Apr. 4, 2024

(54) REVERSIBLE FUEL CELL AND ELECTROLYZER SYSTEM

(71) Applicant: CUMMINS INC., Columbus, IN (US)

(72) Inventors: John Robert PENDRAY, Blaine, MN (US); Achyut PAUDEL, Columbus, IN (US); Lars Krister HENRICHSEN, Columbus, IN (US); Enrique GARCIA-TORRESOLA, Columbus, IN (US); Jinyong LUO, Columbus, IN (US)

(21) Appl. No.: 18/478,739

(22) Filed: Sep. 29, 2023

Related U.S. Application Data
(60) Provisional application No. 63/412,112, filed on Sep. 30, 2022.

(51) Int. Cl. H01M 8/18; C25B 1/04; C25B 9/19; C25B 13/07; C25B 15/08; H01M 8/04014; H01M 8/04089; H01M 8/04119

(52) U.S. Cl. CPC H01M 8/186; C25B 1/04; C25B 9/19; C25B 13/07; C25B 15/083; H01M 8/04014; H01M 8/04097; H01M 8/04164; H01M 2008/1293

(57) ABSTRACT

A method includes providing steam to the solid oxide fuel cell stack, splitting exhaust gas from the cell stack into two portions, a first portion directed to a superheater and a second portion directed to an ejector and to a hydrogen separator. At least part of the first portion of the exhaust gas that is directed to the superheater is subsequently boiled in a boiler and then returned to the superheater. After being returned to the superheater, this part is directed to the ejector as high pressure steam so as to drive the ejector.

### CROSS-REFERENCE TO RELATED APPLICATIONS

This nonprovisional application claims the benefit and priority, under 35 U.S.C. § 119(e) and any other applicable laws or statutes, to U.S. Provisional Application Ser. No. 63/412,112 filed on Sep. 30, 2022, the entire disclosure of which is hereby expressly incorporated herein by reference.

### GOVERNMENT INTEREST CLAUSE

Embodiments of the present disclosure were made with government support under Contract No. DE-FE0031971 awarded by the U.S. Department of Energy. The government may have certain rights.

### TECHNICAL FIELD

The present invention is directed to a reversible solid oxide fuel cell system that optimizes operational performance.

### BACKGROUND

Concerns about global climate change are increasing with the level of CO₂ in our atmosphere caused by the use of combustion-based methods to generate power from fossil fuels. As such, demand for efficient and reliable electrical power is escalating and outpacing the improvements found in conventional power sources. Applications in which compact, lightweight, energy-dense power supplies find immediate application include portable power generators, combined heat and power systems, and auxiliary power units for vehicles.

Fuel cells offer a viable approach to increase efficiency of power generation from fossil fuels while greatly reducing emissions of pollutants and greenhouse gases. Fuel cells are electrochemical devices, which can efficiently convert energy stored in fuels to electrical energy. Electrolyzer cells are electrochemical devices that can generate a fuel, such as hydrogen, by using electricity to reduce a given material, such as water.

Fuel cells and electrolyzer cells may be reversible cells capable of operating in both hydrogen-consuming (e.g., fuel cell) and hydrogen-generating (e.g., electrolyzer) mode. In electrolysis mode, reversible fuel cells reduce a previously oxidized fuel, such as water generated from hydrogen during the fuel cell mode, to an unoxidized fuel, such as hydrogen, using electrical energy as an input. In electrolysis mode, the electrode of the reversible fuel cell is exposed to water vapor generated during fuel cell mode or water vapor from another source. In fuel cell mode, the electrode of the reversible fuel cell is exposed to a fuel, such as hydrogen gas.

### SUMMARY

Embodiments of the present disclosure are included to meet these and other needs.

In one aspect of the present disclosure, described herein, a method of circulating a reducing gas produced in a solid oxide fuel cell stack during electrolysis includes providing steam to the solid oxide fuel cell stack as a source of heat or water, splitting an exhaust gas from the solid oxide fuel cell stack into a first portion and a second portion, the first portion being directed to a superheater and the second portion being directed to a steam-driven ejector disposed downstream of the solid oxide fuel cell stack, and splitting the second portion of the exhaust gas into a reducing gas and a steam mixture.

In some embodiments, the method further includes directing the reducing gas to the steam-driven ejector and the steam mixture to a hydrogen separator including a water condensation unit, and assisting water electrolysis by feeding externally supplied air to the solid oxide fuel cell stack to dilute oxygen. At least part of the first portion of the exhaust gas that is directed to the superheater is subsequently boiled in a boiler and then returned to the superheater, and, after being returned to the superheater, is directed to the steam-driven ejector as high pressure steam so as to drive the steam-driven ejector.

In some embodiments, the reducing gas is hydrogen. In some examples, external steam is injected into the solid oxide fuel cell stack as a source of hydrogen. In further embodiments, the solid oxide fuel cell stack is located downstream of an ejector outlet and a reformer. In some embodiments, a first part of the hydrogen and the steam mixture is passed to the hydrogen separator and the water condensation unit to separate water and the hydrogen. In some embodiments, at least a further part of the first portion of the exhaust gas that is directed to the superheater is directed to a condenser and is subsequently recycled to join the first part of the hydrogen and the steam mixture in the hydrogen separator.

In some embodiments, an excess gas from the condenser is passed through a burner to vent off exhaust gases. In some examples, a portion of the hydrogen is directed from the solid oxide fuel cell stack to a superheater. In further non-limiting examples, the superheater is configured to produce the steam mixture form the portion of the hydrogen and direct the steam mixture to the steam driven ejector.

In a further aspect of the present disclosure, described herein, a method of generating pure oxygen and pure hydrogen in a solid oxide fuel cell stack during electrolysis includes providing steam to the solid oxide fuel cell stack as a source of heat or water, splitting an exhaust gas from the solid oxide fuel cell stack into a first portion and a second portion, the first portion being directed to a superheater and the second portion being directed to a steam-driven ejector disposed downstream of the solid oxide fuel cell stack, and splitting the second portion of the exhaust gas into a reducing gas and a steam mixture.

In some embodiments, the method further includes directing the reducing gas to the steam-driven ejector and the steam mixture to a hydrogen separator including a water condensation unit. At least part of the first portion of the exhaust gas that is directed to the superheater is subsequently boiled in a boiler and then returned to the superheater, and, after being returned to the superheater, is directed to the steam-driven ejector as high pressure steam so as to drive the steam-driven ejector.

In some embodiments, the external steam is injected to the solid oxide fuel cell stack, downstream to an ejector outlet and a reformer as a source of hydrogen. In some examples, a first part of the hydrogen and the steam mixture is passed to the hydrogen separator and the water condensation unit to separate water and the hydrogen. In some non-limiting examples, at least a further part of the first portion of the exhaust gas that is directed to the superheater is directed to a condenser and is subsequently recycled to join the first part of the hydrogen and the steam mixture in the hydrogen separator. In some embodiments, the method further includes assisting water electrolysis by feeding externally supplied air to the solid oxide fuel cell stack to dilute oxygen.

In a further aspect of the present disclosure, described herein, a reversible solid oxide fuel cell system for use during electrolysis includes a solid oxide fuel cell stack, an ejector fluidly coupled to the fuel cell stack and configured to receive exhaust gas from the solid oxide fuel cell stack, and a first flow splitter configured to split the exhaust gas from the solid oxide fuel cell stack into a first portion and a second portion, the first portion being directed to a superheater and the second portion being directed to the ejector.

The system further includes a second flow splitter arranged downstream of the first flow splitter and configured to split the second portion of the exhaust gas into a reducing gas and a steam mixture, the reducing gas being directed to the ejector, a hydrogen separator including a water condensation unit arranged downstream from the ejector and configured to receive the steam mixture generated from the solid oxide fuel cell stack, and two or more parallel heat exchangers arranged downstream of the ejector and configured to separately receive the steam mixture and oxygen generated by the solid oxide fuel cell stack to maximize heat recovery. In some embodiments, at least part of the first portion of the exhaust gas that is directed to the superheater is subsequently boiled in a boiler and then returned to the superheater, and, after being returned to the superheater, is directed to the steam-driven ejector as high pressure steam so as to drive the steam-driven ejector.

In some embodiments, external steam is injected to the solid oxide fuel cell stack, downstream to an ejector outlet and a reformer as a source of hydrogen. In some embodiments, a first part of the hydrogen and the steam mixture is passed to the hydrogen separator and the water condensation unit to separate a water and the hydrogen. In some embodiments, at least a further part of the first portion of the exhaust gas that is directed to the superheater is directed to a condenser and is subsequently recycled to join the first part of the hydrogen and the steam mixture in the hydrogen separator. In some embodiments, water electrolysis is assisted by feeding externally supplied air to the solid oxide fuel cell stack to dilute oxygen. In some embodiments, the reducing gas is hydrogen.

### BRIEF DESCRIPTION OF THE DRAWINGS

FIG. 1A is a schematic view of an exemplary fuel cell system including an air delivery system, a hydrogen delivery system, and a fuel cell module including a stack of multiple fuel cells;

FIG. 1B is a cutaway view of an exemplary fuel cell system including an air delivery system, hydrogen delivery systems, and a plurality of fuel cell modules each including multiple fuel cell stacks;

FIG. 1C is a perspective view of an exemplary repeating unit of a fuel cell stack of the fuel cell system of FIG. 1A;

FIG. 1D is a cross-sectional view of an exemplary repeating unit of the fuel cell stack of FIG. 1C;

FIG. 2A is a perspective view of an electrolyzer cell stack according to the present disclosure;

FIG. 2B is a schematic view of an electrolysis system configured to utilize the electrolyzer cells stack of FIG. 2A;

FIG. 2C is a schematic view of an additional portion of the electrolysis system of FIG. 2B;

FIG. 3 is a schematic diagram of a baseline reversible solid oxide fuel cell system with an ejector;

FIG. 4 is a schematic diagram of an embodiment of the reversible solid oxide fuel cell system in electrolysis mode and producing pure hydrogen; and

FIG. 5 is a schematic diagram of another embodiment of the reversible solid oxide fuel cell system in electrolysis mode in which pure oxygen is generated.

### DETAILED DESCRIPTION

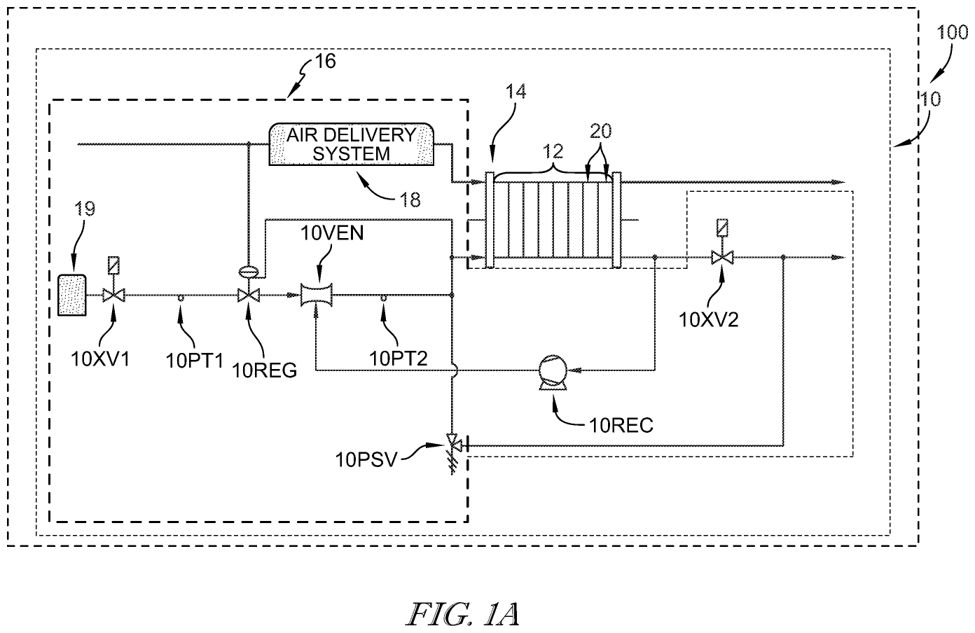

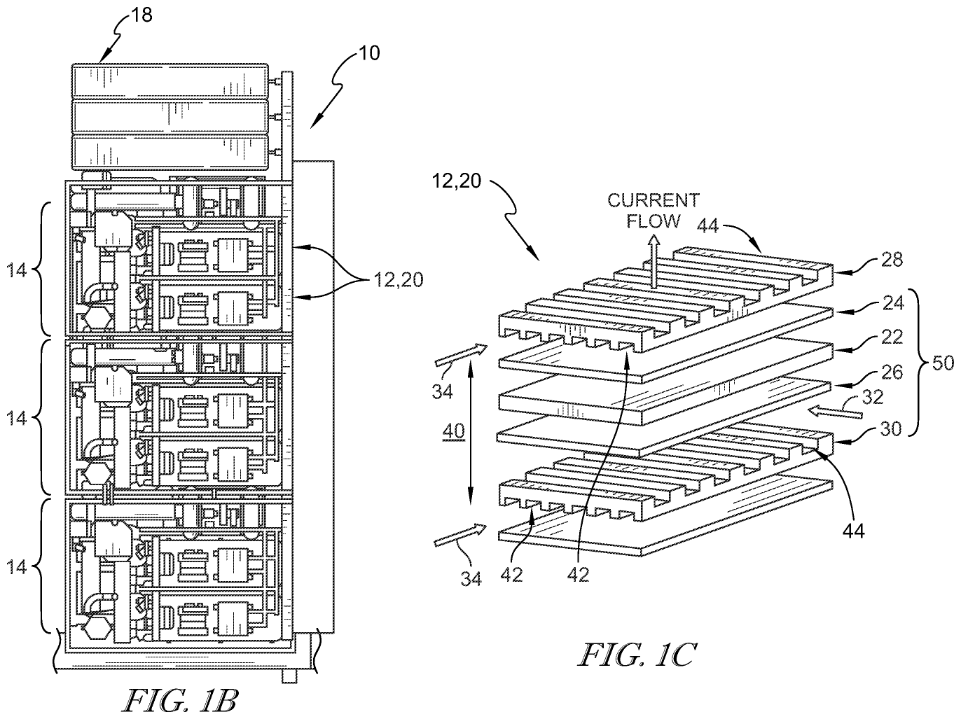

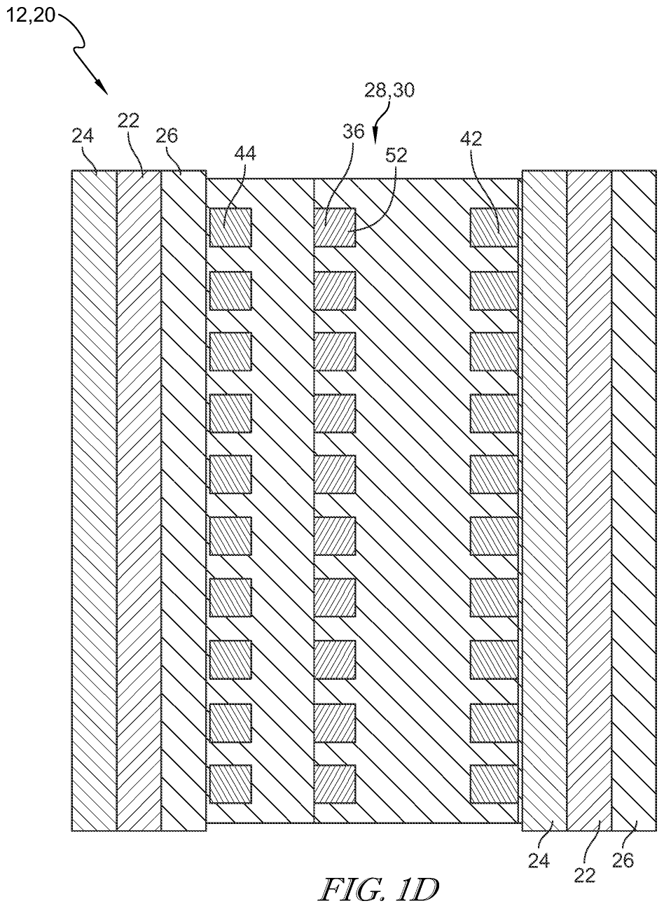

As shown in FIG. 1A, fuel cell systems 10 often include one or more fuel cell stacks 12 (“STK”) or fuel cell modules 14 connected to a balance of plant (BOP) 16, including various components, to support the electrochemical conversion, generation, and/or distribution of electrical power to help meet modern day industrial and commercial needs in an environmentally friendly way. As shown in FIGS. 1B and 1C, fuel cell systems 10 may include fuel cell stacks 12 comprising a plurality of individual fuel cells 20. Each fuel cell stack 12 may house a plurality of fuel cells 20 assembled together in series and/or in parallel. The fuel cell system 10 may include one or more fuel cell modules 14 as shown in FIGS. 1A and 1B.

Each fuel cell module 14 may include a plurality of fuel cell stacks 12 and/or a plurality of fuel cells 20. The fuel cell module 14 may also include a suitable combination of associated structural elements, mechanical systems, hardware, firmware, and/or software that is employed to support the function and operation of the fuel cell module 14. Such items include, without limitation, piping, sensors, regulators, current collectors, seals, and insulators.

The fuel cells 20 in the fuel cell stacks 12 may be stacked together to multiply and increase the voltage output of a single fuel cell stack 12. The number of fuel cell stacks 12 in a fuel cell system 10 can vary depending on the amount of power required to operate the fuel cell system 10 and meet the power need of any load. The number of fuel cells 20 in a fuel cell stack 12 can vary depending on the amount of power required to operate the fuel cell system 10 including the fuel cell stacks 12.

The number of fuel cells 20 in each fuel cell stack 12 or fuel cell system 10 can be any number. For example, the number of fuel cells 20 in each fuel cell stack 12 may range from about 100 fuel cells to about 1000 fuel cells, including any specific number or range of number of fuel cells 20 comprised therein (e.g., about 200 to about 800). In an embodiment, the fuel cell system 10 may include about 20 to about 1000 fuel cells stacks 12, including any specific number or range of number of fuel cell stacks 12 comprised therein (e.g., about 200 to about 800). The fuel cells 20 in the fuel cell stacks 12 within the fuel cell module 14 may be oriented in any direction to optimize the operational efficiency and functionality of the fuel cell system 10.

The fuel cells 20 in the fuel cell stacks 12 may be any type of fuel cell 20. The fuel cell 20 may be a polymer electrolyte membrane or proton exchange membrane (PEM) fuel cell, an anion exchange membrane fuel cell (AEMFC), an alkaline fuel cell (AFC), a molten carbonate fuel cell (MCFC), a direct methanol fuel cell (DMFC), a regenerative fuel cell (RFC), a phosphoric acid fuel cell (PAFC), or a solid oxide fuel cell (SOFC). In an exemplary embodiment, the fuel cells 20 may be a polymer electrolyte membrane or proton exchange membrane (PEM) fuel cell or a solid oxide fuel cell (SOFC).

In an embodiment shown in FIG. 1C, the fuel cell stack 12 includes a plurality of proton exchange membrane (PEM) fuel cells 20. Each fuel cell 20 includes a single membrane electrode assembly (MEA) 22 and a gas diffusion layers (GDL) 24, 26 on either or both sides of the membrane electrode assembly (MEA) 22 (see FIG. 1C). The fuel cell 20 further includes a bipolar plate (BPP) 28, 30 on the external side of each gas diffusion layers (GDL) 24, 26, as shown in FIG. 1C. The above-mentioned components, in particular the bipolar plate 30, the gas diffusion layer (GDL) 26, the membrane electrode assembly (MEA) 22, and the gas diffusion layer (GDL) 24 comprise a single repeating unit 50.

The bipolar plates (BPP) 28, 30 are responsible for the transport of reactants, such as fuel 32 (e.g., hydrogen) or oxidant 34 (e.g., oxygen, air), and cooling fluid 36 (e.g., coolant and/or water) in a fuel cell 20. The bipolar plates (BPP) 28, 30 can uniformly distribute reactants 32, 34 to an active area 40 of each fuel cell 20 through oxidant flow fields 42 and/or fuel flow fields 44 formed on outer surfaces of the bipolar plates (BPP) 28, 30. The active area 40, where the electrochemical reactions occur to generate electrical power produced by the fuel cell 20, is centered, when viewing the stack 12 from a top-down perspective, within the membrane electrode assembly (MEA) 22, the gas diffusion layers (GDL) 24, 26, and the bipolar plate (BPP) 28, 30.

The bipolar plates (BPP) 28, 30 may each be formed to have reactant flow fields 42, 44 formed on opposing outer surfaces of the bipolar plate (BPP) 28, 30, and formed to have coolant flow fields 52 located within the bipolar plate (BPP) 28, 30, as shown in FIG. 1D. For example, the bipolar plate (BPP) 28, 30 can include fuel flow fields 44 for transfer of fuel 32 on one side of the plate 28, 30 for interaction with the gas diffusion layer (GDL) 26, and oxidant flow fields 42 for transfer of oxidant 34 on the second, opposite side of the plate 28, 30 for interaction with the gas diffusion layer (GDL) 24. As shown in FIG. 1D, the bipolar plates (BPP) 28, 30 can further include coolant flow fields 52 formed within the plate (BPP) 28, 30, generally centrally between the opposing outer surfaces of the plate (BPP) 28, 30. The coolant flow fields 52 facilitate the flow of cooling fluid 36 through the bipolar plate (BPP) 28, 30 in order to regulate the temperature of the plate (BPP) 28, 30 materials and the reactants. The bipolar plates (BPP) 28, 30 are compressed against adjacent gas diffusion layers (GDL) 24, 26 to isolate and/or seal one or more reactants 32, 34 within their respective pathways 44, 42 to maintain electrical conductivity, which is required for robust operation of the fuel cell 20 (see FIGS. 1C and 1D).

The fuel cell system 10 described herein, may be used in stationary and/or immovable power system, such as industrial applications and power generation plants. The fuel cell system 10 may also be implemented in conjunction with an air delivery system 18. Additionally, the fuel cell system 10 may also be implemented in conjunction with a hydrogen delivery system and/or a source of hydrogen 19 such as a pressurized tank, including a gaseous pressurized tank, cryogenic liquid storage tank, chemical storage, physical storage, stationary storage, an electrolysis system or an electrolyzer. In one embodiment, the fuel cell system 10 is connected and/or attached in series or parallel to a hydrogen delivery system and/or a source of hydrogen 19, such as one or more hydrogen delivery systems and/or sources of hydrogen 19 in the BOP 16 (see FIG. 1A). In another embodiment, the fuel cell system 10 is not connected and/or attached in series or parallel to a hydrogen delivery system and/or a source of hydrogen 19.

In some embodiments, the fuel cell system 10 may include an on/off valve 10XV1, a pressure transducer 10PT1, a mechanical regulator 10REG, and a venturi 10VEN arranged in operable communication with each other and downstream of the hydrogen delivery system and/or source of hydrogen 19. The pressure transducer 10PT1 may be arranged between the on/off valve 10XV1 and the mechanical regulator 10REG. In some embodiments, a proportional control valve may be utilized instead of a mechanical regulator 10REG. In some embodiments, a second pressure transducer 10PT2 is arranged downstream of the venturi 10VEN, which is downstream of the mechanical regulator 10REG.

In some embodiments, the fuel cell system 10 may further include a recirculation pump 10REC downstream of the stack 12 and operably connected to the venturi 10VEN. The fuel cell system 10 may also include a further on/off valve 10XV2 downstream of the stack 12, and a pressure transfer valve 10PSV.

The present fuel cell system 10 may also be comprised in mobile applications. In an exemplary embodiment, the fuel cell system 10 is in a vehicle and/or a powertrain 100. A vehicle 100 comprising the present fuel cell system 10 may be an automobile, a pass car, a bus, a truck, a train, a locomotive, an aircraft, a light duty vehicle, a medium duty vehicle, or a heavy-duty vehicle. Type of vehicles 100 can also include, but are not limited to commercial vehicles and engines, trains, trolleys, trams, planes, buses, ships, boats, and other known vehicles, as well as other machinery and/or manufacturing devices, equipment, installations, among others.

The vehicle and/or a powertrain 100 may be used on roadways, highways, railways, airways, and/or waterways. The vehicle 100 may be used in applications including but not limited to off highway transit, bobtails, and/or mining equipment. For example, an exemplary embodiment of mining equipment vehicle 100 is a mining truck or a mine haul truck.

In addition, it may be appreciated by a person of ordinary skill in the art that the fuel cell system 10, fuel cell stack 12, and/or fuel cell 20 described in the present disclosure may be substituted for any electrochemical system, such as an electrolysis system (e.g., an electrolyzer), an electrolyzer stack, and/or an electrolyzer cell (EC), respectively. As such, in some embodiments, the features and aspects described and taught in the present disclosure regarding the fuel cell system 10, stack 12, or cell 20 also relate to an electrolyzer, an electrolyzer stack, and/or an electrolyzer cell (EC). In further embodiments, the features and aspects described or taught in the present disclosure do not relate, and are therefore distinguishable from, those of an electrolyzer, an electrolyzer stack, and/or an electrolyzer cell (EC).

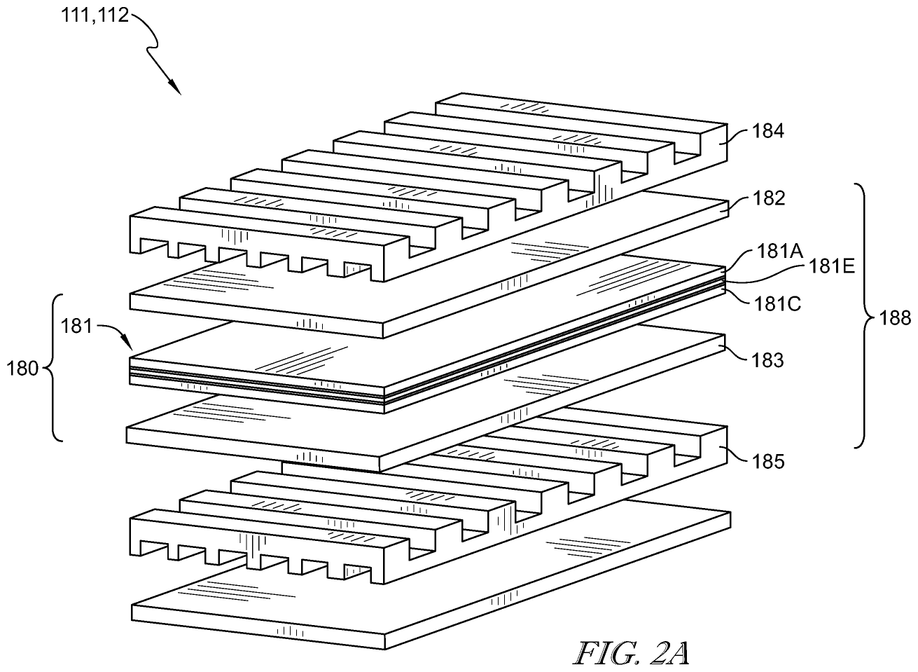

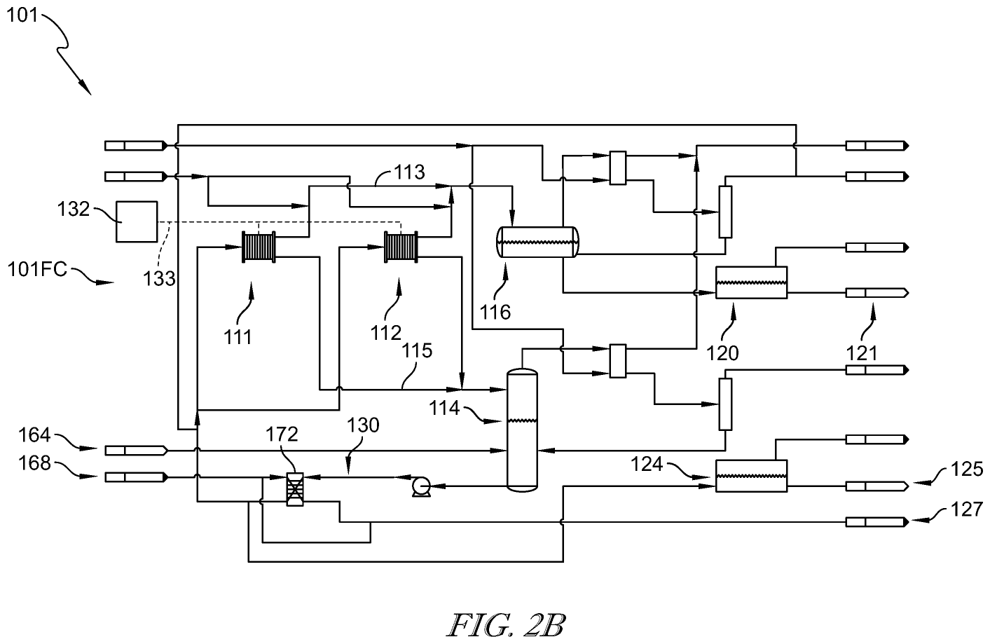

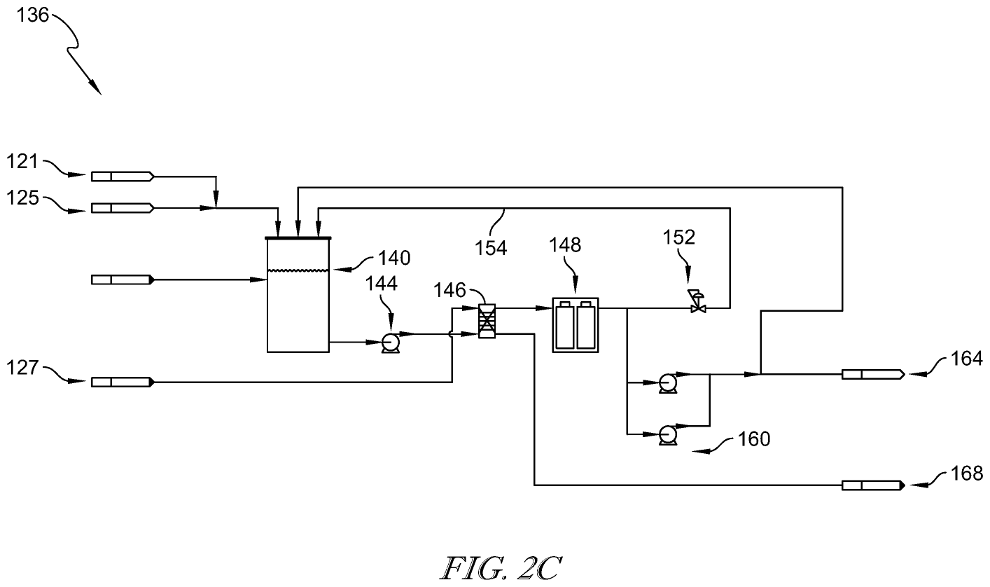

As shown in FIGS. 2A and 2B, electrolysis systems 101 are typically configured to utilize water and electricity to produce hydrogen and oxygen. An electrolysis system 101 typically includes one or more electrolyzer cells 180 that utilize electricity to chemically produce substantially pure hydrogen 113 and oxygen 115 from deionized water 130. Often the electrical source for the electrolysis systems 101 is produced from power or energy generation systems, including renewable energy systems such as wind, solar, hydroelectric, and geothermal sources for the production of green hydrogen. In turn, the pure hydrogen produced by the electrolysis systems 101 is often utilized as a fuel or energy source for those same power generation systems, such as fuel cell systems. Alternatively, the pure hydrogen produced by the electrolysis systems 101 may be stored for later use.

The typical electrolyzer cell 180, or electrolytic cell, is comprised of multiple assemblies compressed and bound into a single assembly, and multiple electrolyzer cells 180 may be stacked relative to each other, along with bipolar plates (BPP) 184, 185 therebetween, to form an electrolyzer cell stack (for example, electrolyzer cell stacks 111, 112 in FIG. 2B). Each electrolyzer cell stack 111, 112 may house a plurality of electrolyzer cells 180 connected together in series and/or in parallel. The number of electrolyzer cell stack 111, 112 in the electrolysis systems 101 can vary depending on the amount of power required to meet the power need of any load (e.g., fuel cell stack). The number of electrolyzer cells 180 in an electrolyzer cell stack 111, 112 can vary depending on the amount of power required to operate the electrolysis systems 101 including the electrolyzer cell stack 111, 112.

An electrolyzer cell 180 includes a multi-component membrane electrode assembly (MEA) 181 that has an electrolyte 181E, an anode 181A, and a cathode 181C. Typically, the anode 181A, cathode 181C, and electrolyte 181E of the membrane electrode assembly (MEA) 181 are configured in a multi-layer arrangement that enables the electrochemical reaction to produce hydrogen and/or oxygen via contact of the water with one or more gas diffusion layers 182, 183. The gas diffusion layers (GDL) 182, 183, which may also be referred to as porous transport layers (PTL), are typically located on one or both sides of the MEA 181. Bipolar plates (BPP) 184, 185 often reside on either side of the GDLs and separate the individual electrolyzer cells 180 of the electrolyzer cell stack 111, 112 from one another. One bipolar plate 185 and the adjacent gas diffusion layers 182, 183 and MEA 181 can form a repeating unit 188.

As shown in FIGS. 2B and 2C, an exemplary electrolysis system 101 can include two electrolyzer cell stacks 111, 112 and a fluidic circuit 101FC including the various fluidic pathways shown in FIGS. 2B and 2C that is configured to circulate, inject, and purge fluid and other components to and from the electrolysis systems 101. A person skilled in the art would understand that one or a variety of a number of components within the fluidic circuit 101FC, as well as more or less than two electrolyzer cell stacks 111, 112, may be utilized in the electrolysis systems 101. For example, the electrolysis systems 101 may include one electrolyzer cell stack 111, and in other examples, the electrolysis systems 101 may include three or more electrolyzer cell stacks.

The electrolysis systems 101 may include one or more types of electrolyzer cell stacks 111, 112 therein. In the illustrated embodiment, a polymer electrolyte membrane (PEM) electrolyzer cell 180 may be utilized in the stacks 111, 112. A PEM electrolyzer cell 180 typically operates at about 4° C. to about 150° C., including any specific or range of temperatures comprised therein. A PEM electrolyzer cell 180 also typically functions at about 100 bar or less, but can go up to about 1000 bar (including any specific or range of pressures comprised therein), which reduces the total energy demand of the system. A standard electrochemical reaction that occurs in a PEM electrolyzer cell 180 to produce hydrogen is as follows.

2H₂O→O₂+4H⁺+4e⁻ Anode:

4H⁺+4e⁻→2H₂ Cathode:

2H₂O (liquid)→2H₂+O₂ Overall:

Additionally, a solid oxide electrolyzer cell 180 may be utilized in the electrolysis systems 101. A solid oxide electrolyzer cell 180 will function at about 500° C. to about 1000° C., including any specific or range of temperatures comprised therein. A standard electrochemical reaction that occurs in a solid oxide electrolyzer cell 180 to produce hydrogen is as follows.

2O²⁻→O₂+4e⁻ Anode:

2H₂O→4e⁻+2H₂+2O²⁻ Cathode:

2H₂O (liquid)→2H₂+O₂ Overall:

Moreover, an AEM electrolyzer cell 180 may utilized, which uses an alkaline media. An exemplary AEM electrolyzer cell 180 is an alkaline electrolyzer cell 180. Alkaline electrolyzer cells 180 comprise aqueous solutions, such as potassium hydroxide (KOH) and/or sodium hydroxide (NaOH), as the electrolyte. Alkaline electrolyzer cells 180 typically perform at operating temperatures ranging from about 0° C. to about 150° C., including any specific or range of temperatures comprised therein. Alkaline electrolyzer cell 180 generally operate at pressures ranging from about 1 bar to about 100 bar, including any specific or range of pressures comprised therein. A typical hydrogen-generating electrochemical reaction that occurs in an alkaline electrolyzer cell 180 is as follows.

4OH⁻→O₂+2H₂O+4e⁻ Anode:

4H₂O+4e⁻→2H₂+4OH⁻ Cathode:

2H₂O 2H₂+O₂ Overall:

As shown in FIG. 2B, the electrolyzer cell stacks 111, 112 include one or more electrolyzer cells 180 that utilize electricity to chemically produce substantially pure hydrogen and oxygen from water. In turn, the pure hydrogen produced by the electrolyzer may be utilized as a fuel or energy source. As shown in FIG. 2B, the electrolyzer cell stack 111, 112 outputs the produced hydrogen along a fluidic connecting line 113 to a hydrogen separator 116, and also outputs the produced oxygen along a fluidic connecting line 115 to an oxygen separator 114.

The hydrogen separator 116 may be configured to output pure hydrogen gas and also send additional output fluid to a hydrogen drain tank 120, which then outputs fluid to a deionized water drain 121. The oxygen separator 114 may output fluid to an oxygen drain tank 124, which in turn outputs fluid to a deionized water drain 125. A person skilled in the art would understand that certain inputs and outputs of fluid may be pure water or other fluids such as coolant or byproducts of the chemical reactions of the electrolyzer cell stacks 111, 112. For example, oxygen and hydrogen may flow away from the cell stacks 111, 112 to the respective separators 114, 116. The system 101 may further include a rectifier 132 configured to convert electricity 133 flowing to the cell stacks 111, 112 from alternating current (AC) to direct current (DC).

The deionized water drains 121, 125 each output to a deionized water tank 140, which is part of a polishing loop 136 of the fluidic circuit 101FC, as shown in FIG. 2C. Water with ion content can damage electrolyzer cell stacks 111, 112 when the ionized water interacts with internal components of the electrolyzer cell stacks 111, 112. The polishing loop 136, shown in greater detail in FIG. 2C, is configured to deionize the water such that it may be utilized in the cell stacks 111, 112 and not damage the cell stacks 111, 112.

In the illustrated embodiment, the deionized water tank 140 outputs fluid, in particular water, to a deionized water polishing pump 144. The deionized water polishing pump 144 in turn outputs the water to a water polishing heat exchanger 146 for polishing and treatment. The water then flows to a deionized water resin tank 148.

Coolant is directed through the electrolysis systems 101, in particular through a deionized water heat exchanger 172 that is fluidically connected to the oxygen separator 114. The coolant used to cool said water may also be subsequently fed to the water polishing heat exchanger 146 via a coolant input 127 for polishing. The coolant is then output back to the deionized water heat exchanger 172 for cooling the water therein.

After the water is output from the deionized water polishing heat exchanger 146 and subsequently to the deionized water resin tank 148, a portion of the water may be fed to deionized water high pressure feed pumps 160. Another portion of the water may be fed to a deionized water pressure control valve 152, as shown in FIG. 2C. The portion of the water that is fed to the deionized water pressure control valve 152 flows through a recirculation fluidic connection 154 that allows the water to flow back to the deionized water tank 140 for continued polishing.

In some embodiments, the electrolysis systems 101 may increase deionized water skid for polishing water flow to flush out ions within the water at a faster rate. The portion of the water that is fed to the deionized water high pressure feed pumps 160 is then output to a deionized water feed 164, which then flows into the oxygen separator 114 for recirculation and eventual reusage in the electrolyzer cell stacks 111, 112. This process may then continuously repeat.

The electrolysis systems 101 described herein, may be used in stationary and/or immovable power system, such as industrial applications and power generation plants. The electrolysis systems 101 may also be implemented in conjunction with other electrolysis systems 101.

The present electrolysis systems 101 may be comprised in stationary or mobile applications. The electrolysis systems 101 may be in a vehicle or a powertrain 100. A vehicle or powertrain 100 comprising the electrolysis systems 101 may be an automobile, a pass car, a bus, a truck, a train, a locomotive, an aircraft, a light duty vehicle, a medium duty vehicle, or a heavy-duty vehicle.

In addition, it may be appreciated by a person of ordinary skill in the art that the electrolysis system 101, electrolyzer stack 111, 112, and/or the electrolyzer cell 180 described in the present disclosure may be substituted for any electrochemical system, such as a fuel cell system, a fuel cell stack, and/or a fuel cell (FC), respectively. As such, in some embodiments, the features and aspects described and taught in the present disclosure regarding electrolysis system 101, electrolyzer stack 111, 112, and/or the electrolyzer cell 180 also relate a fuel cell system, a fuel cell stack, and/or a fuel cell (FC), respectively. In further embodiments, the features and aspects described or taught in the present disclosure do not relate, and are therefore distinguishable from, those of a fuel cell system, a fuel cell stack, and/or a fuel cell (FC).

One aspect of the present disclosure is directed to systems 200, 300, 400 and methods for recirculating reducing gases in a fuel cell 220, 320, 420 of a fuel cell stack 210, 310, 410. Another aspect of the present disclosure is directed to systems 300, 400 and methods for generating pure hydrogen from a fuel cell 320, 420 of a fuel cell stack 310, 410. Another aspect of the present disclosure is directed to systems 400 and methods for generating pure oxygen from a fuel cell 420 of a fuel cell stack 410. In one embodiment of the present disclosure, the system 200, 300, 400 efficiently recovers hydrogen and water that drives an ejector 202, 302, 402 to recirculate reducing gases.

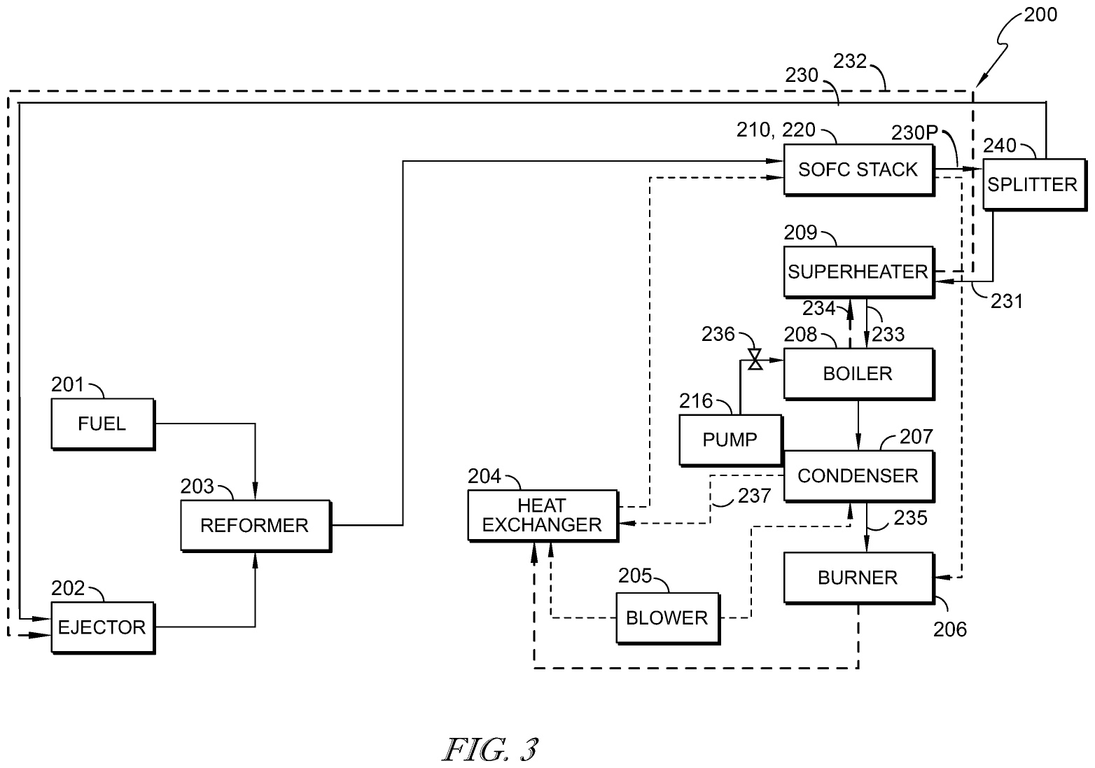

While any type of electrochemical cell (e.g., a fuel cell 20, as described above, or an electrolyzer cell 180, as described above) may be utilized in the present disclosure in the fuel cell stacks 210, 310, 410 described below, one exemplary type of electrochemical cell being a reversible cell such as a reversible fuel cell 220, 320, 420 or a reversible electrolyzer cell 220, 320, 420, as shown in FIGS. 3-5. Specifically, a reversible fuel cell 220, 320, 420 or a reversible electrolyzer cell 220, 320, 420 contains a solid oxide (i.e., ceramic) electrolyte (e.g., electrolyte 181E). In order to utilize energy from hydrocarbon fuels, solid oxide fuel cells often use a process called steam-methane reforming where steam with high temperatures (typically about 600° C. to about 1000° C.) reacts with methane in the presence of a catalyst to produce hydrogen.

However, reformation of hydrocarbon fuels may produce various impurities at levels that can be detrimental to fuel cell operation. Typical fuel impurities include, but are not limited to carbon monoxide (CO), ammonia (NH₃), hydrogen sulfide (H₂S), and/or combinations thereof. Additionally, ambient air might contains pollutants, such as NOₓ or NₓOₓ (e.g., NO, NO₂, NO₄, N₂O, etc.) and SO₂ which are generated from fossil fuel combustion, and also degrade fuel cell performance. Ambient air refers to air freely obtained from the atmosphere, i.e. at atmospheric temperature and pressure.

Solid oxide fuel cells (SOFCs), which operate at high temperatures (typically about 600° C. to about 1000° C., including any specific or range of temperature comprised therein), are much less sensitive to impurities in hydrocarbon fuels. This insensitivity of SOFCs to fuel impurities minimizes the amount of gas purification steps required to obtain an operational cell fuel. Therefore, the ability for the present reversible cell 220, 320, 420 to utilize fuel that is not pure, greatly increases the power generation efficiency and reduces system complexity of the reversible electrochemical cell 220, 320, 420. Accordingly, in the present disclosure, reversible solid oxide fuel cells 220, 320, 420 or electrolyzer cells 220, 320, 420 are able to directly operate on certain hydrocarbon fuels, such as methane, methanol, or ethanol, without an initial reforming step, which is advantageous.

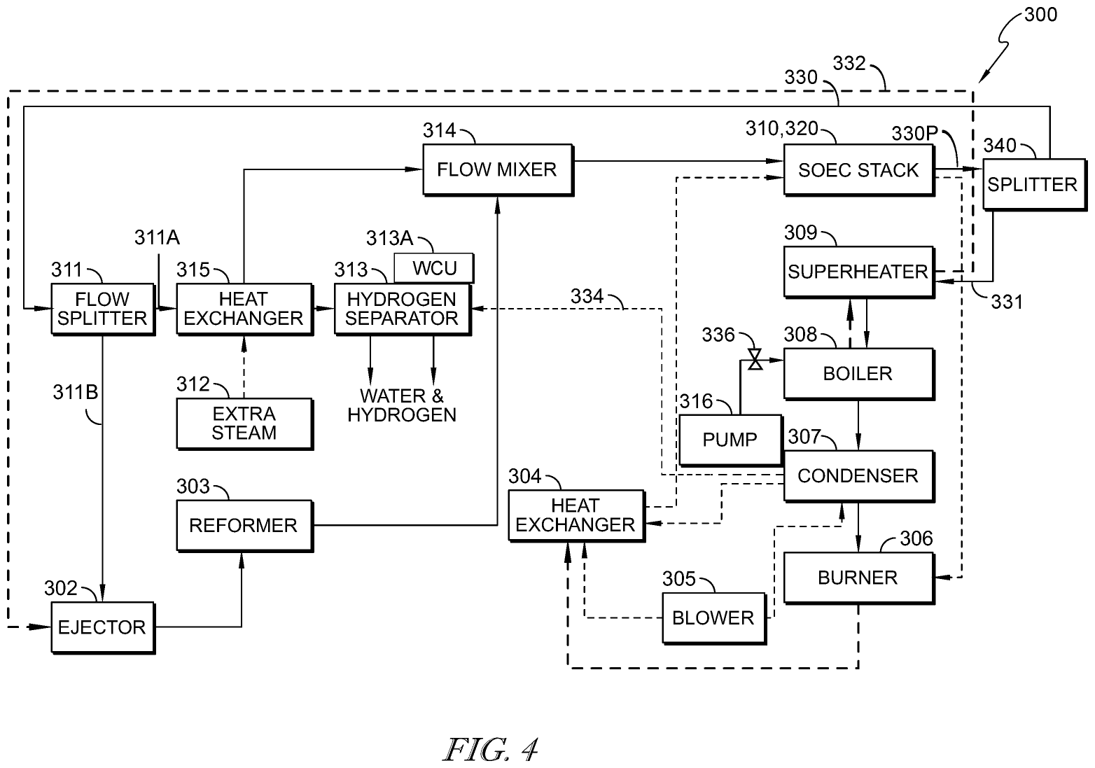

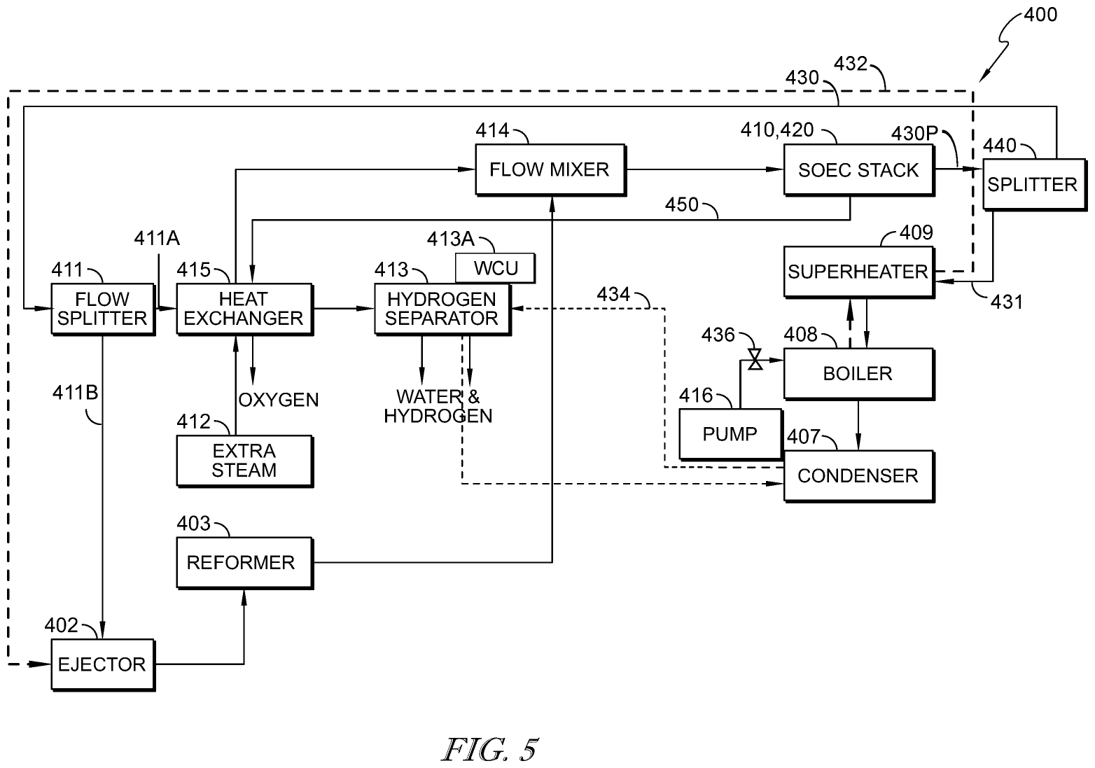

A reversible solid oxide fuel cell (“SOFC”) 220, 320, 420 generates electrical energy by consuming fuel and/or oxidizing fuel in a fuel cell mode. Conversely, the reversible solid oxide fuel cell may operate as a solid oxide electrolyte cell (“SOEC”) 220, 320, 420 that generates hydrogen (e.g., fuel 32) and oxidant (e.g. oxygen 34) from water using electrical energy in an electrolysis mode. By way of non-limiting examples, the reversible solid oxide fuel cell is shown operating in a fuel cell mode in FIG. 3 and an electrolysis mode in FIGS. 4 and 5 (denoted by solid oxide fuel cell (“SOFC”) 210, and solid oxide electrolyte cell (“SOEC”) 310, 410, respectively). It is noted that, although the phrase “reversible solid oxide fuel cell (SOFC) 220, 320, 420” may be used herein to refer to a fuel cell mode, the references to reversible solid oxide fuel cell (SOFC) 220, 320, 420 herein may also refer to a reversible solid oxide electrolyte cell (SOEC).

The reversible solid oxide fuel cell 220, 320, 420 contains a ceramic electrolyte, such as the electrolyte 181E, described above and shown in FIG. 2A (e.g., yttria stabilized zirconia), an oxidant electrode (e.g., a cathode, such as the cathode 181C, as described above and shown in FIG. 2A), and a fuel electrode (e.g., an anode, such as the anode 181A as described above and shown in FIG. 2A). It is noted that, although the electrolyte, cathode, and anode are referred to as 181E, 181C, 181A below, the electrolyte, cathode, and anode may also include the membrane electrode assembly (MEA) 22 and/or a gas diffusion layer (GDL) 24, 26, as described above and shown in FIGS. 1C and 1D.

The cathode 181C is exposed to an oxidizer, such as air, in the fuel cell mode. The cathode 181C is also exposed to a generated oxidant, such as oxygen gas 34, in the electrolysis mode. The cathode 181C may be made of a ceramic material, such as lanthanum strontium manganite, lanthanum strontium cobaltite, and/or combinations thereof.

For solid oxide fuel cells 220, 320, 420 to be of practical application, they should operate using fuels that are easily available. This requires that power supplies or power sources operate on conventional fuels, such as gasoline, natural gas, and/or diesel. Hydrocarbon fuel (e.g. fuel 32) is reacted (reformed) over a catalyst with air and/or steam to produce a mixture of hydrogen and carbon monoxide (and in some cases methane) gas before delivery to the fuel cell 220, 320, 420.

When in the electrolysis mode, a reversible solid oxide fuel cell 220, 320, 420 can operate as an electrolyzer within an energy system. Such an electrolyzer cell 220, 320, 420 can be used to provide grid services, energy storage and/or fuel. Alternatively, such an electrolyzer cell 220, 320, 420 can be used to produce hydrogen from electricity produced from other renewable resources. The electrolyzer cell 220, 320, 420 may be configured to operate at rates that may vary frequently or quickly. These varying rates require varying rates of electricity consumption and/or to operate at a specified power consumption.

Water electrolysis (“electrolysis”) converts electrical energy into chemical energy in the form of hydrogen. The hydrogen produced during electrolysis is most valuable when consumed as an essentially pure fuel (e.g., green hydrogen) or an industrial chemical. However, the hydrogen also has value when blended with other gases. Notably, the value of hydrogen tends to decline with decreased hydrogen concentration. For example, relatively pure hydrogen has significant value since it can also serve as fuel and be converted back into electricity.

The electrolyzer cell 220, 320, 420 can be used to provide value to a grid service by consuming power to help balance or regulate an electrical grid. As previously described, hydrogen can be considered as a fuel or an industrial chemical, but hydrogen can also be seen as an energy storage or a transporting medium. Therefore, an electrolyzer 220, 320, 420 can be considered as a device for producing hydrogen, and also as a device for consuming hydrogen, such as for providing electrical grid services.

In fuel cell mode, a reversible solid oxide fuel cell 220, 320, 420 may include a motive force to drive recirculation of an anode off gas 230, 330, 430, as shown in FIGS. 3-5. The motive force may be provided by an anode off gas 230, 330, 430, recirculation blower 205, 305, 405, one or more fuel-driven or steam-driven ejectors 202, 302, 402, or some combination of a blower 205, 305, 405 and one or more ejector 202, 302, 402 types. In practice, some recirculation motive force solutions are more efficient and cost effective than others.

For example, a blower 205, 305, 405 used to recirculate an anode off gas through the fuel cell 220, 320, 420 requires cooling, as shown in FIGS. 3-5. The blower 205, 305, 405 also requires recuperation of the anode off gas 230, 330, 430 recirculation gases, which adds cost and may, in some cases, reduce overall energy efficiency of the reversible solid oxide fuel cell system 200, 300, 400. As another example, while fuel-driven ejectors 202, 302, 402 are moderate in cost, they require high fuel pressure and may be unable to provide sufficient off gas recirculation rates.

A portion of the anode off gas 230, 330, 430 that is not recirculated, referred to as an anode off gas slip stream 231, 331, 431, may be mixed with a cathode off gas and oxidized. Certain versions of steam-driven ejectors 202, 302, 402 may rely on the anode off gas 230, 330, 430 recirculation for sufficient water supply rather than on the anode off gas slip stream 231, 331, 431. Such steam-driven ejectors 202, 302, 402 thereby consume substantial amounts of energy or cause an increased pressure loss in the fuel cell system 200, 300, 400, or both.

As shown in FIGS. 3-5, for anode off gas 230, 330, 430 recirculation, the system 200, 300, 400 may include a superheater 209, 309, 409. The superheater 209, 309, 409 may be disposed upstream from a boiler 208, 308, 408 and configured to extract thermal energy from the anode off gas slip stream 231, 331, 431 before an off gas from the superheater 209, 309, 409 is directed into the boiler 208, 308, 408 and then to a condenser 207, 307, 407. The superheater 209, 309, 409 may establish thermodynamically favorable conditions for the steam-driven ejector 202, 302, 402, taking advantage of a thermal energy abundant in the anode off gas slip stream 231, 331, 431. The superheater 209, 309, 409 may also protect the boiler 208, 308, 408 from excessive boiling by ensuring that the temperature of the anode off gas slip stream 231, 331, 431 does not exceed the maximum allowed temperature of the boiler 208, 308, 408.

In some embodiments, the maximum allowed temperature of the boiler 208, 308, 408 may be set, indicated, and/or established as a predefined threshold. In some embodiments, this predefined threshold of maximum allowable temperature may be in a range of about 100° C. to about 250° C., including any specific or range of temperature comprised therein. For example, in some embodiments, the predefined threshold may be in a range of about 125° C. to about 240° C. In some embodiments, the predefined threshold may be in a range of about 150° C. to about 230° C. In some embodiments, the predefined threshold may be in a range of about 175° C. to about 220° C. In some embodiments, the predefined threshold may be approximately 200° C. These temperatures, in particular those closer to 200° C., allow for appropriate vaporization before allowing the temperature of the slip stream 231 to exceed the threshold temperature.

As such, the superheater 209, 309, 409 of the present disclosure regulates the thermal energy with respect to the amount of water available in the boiler 208, 308, 408 foregoing the need for an external water supply if moisture in the anode off gas slip stream 231, 331, 431 is sufficiently captured in the condenser 207, 307, 407.

For anode off gas 230, 330, 430 recirculation, the system 200, 300, 400 may include one or more steam-driven ejectors 202, 302, 402, as shown in FIGS. 3-5. The steam-driven ejectors 202, 302, 402 may be configured to have only a portion and/or the full ejector selectively engage or disengage based on a value of one or more operating parameters. Operating parameters of the present system may include but are not limited to, a pressure, a system power, a system voltage, a fuel flow rate, and/or a steam flow rate. In embodiments having two or more ejectors 202, 302, 402, the ejectors 202, 302, 402 may be of the same size, a different size, or some combination thereof with respect to one another.

In one example, a size of a given ejector 202, 302, 402 comprises a combination of a first amount of a steam input 232, 332, 432 and a second amount of an anode gas 230, 330, 430 input to drive the ejector 202, 302, 402, as shown in FIGS. 3-5. As such, a size of the ejector 202, 302, 402 bears on an output of that ejector 202, 302, 402 as affected by a combination of the first amount of steam input 232, 332, 432 and the second amount of an anode gas 230, 330, 430 input. In some instances, an absolute value of a combined input amount to drive the ejector 202, 302, 402 corresponds to the physical size and/or capacity of that ejector 202, 302, 402.

For example, an ejector 202, 302, 402 having a larger combined input amount and/or a larger output amount may be physically larger than an ejector 202, 302, 402 associated with a smaller combined input amount and/or a smaller output amount. In one example, implementing ejectors 202, 302, 402 of different sizes may allow the amount of steam to vary proportionally with the amount of fuel 32. The different sized ejectors also enable a passively adaptive system to generate sufficient anode off gas 230, 330, 430 recirculation rates to accommodate changes in fuel 32 flow.

In some embodiments, the sufficient anode off gas 230, 330, 430 recirculation rate is in a range of about 10% to about 90%. In some embodiments, the sufficient anode off gas 230, 330, 430 recirculation rate is in a range of about 20% to about 80%. In some embodiments, the sufficient anode off gas 230, 330, 430 recirculation rate is in a range of about 30% to about 70%. In some embodiments, the sufficient anode off gas 230, 330, 430 recirculation rate is in a range of about 40% to about 60%. In some embodiments, the sufficient anode off gas 230, 330, 430 recirculation rate is in a range of approximately 50%.

FIG. 3 illustrates one embodiment of a reversible solid oxide fuel cell system 200 in fuel cell mode. A superheater 209 is used to provide heat to an incoming high pressure steam 234. The heat thereby increases the efficiency of the system 200 by reducing the required pressure and flow of the high pressure steam 232. The temperatures of the SOFC 210 in such an embodiment operate in a range of about 500° C. to 900° C., and the superheater 209 is capable of providing approximately a temperature in this range in the high pressure steam 232.

The system 200 includes a fuel source 201 that provides fuel, e.g., a hydrocarbon or hydrogen (e.g. fuel 32 as described above) to a reformer 203. The reformer 203 may be configured to break down complex hydrocarbons present in a fuel stream and/or a steam stream (e.g., the high pressure steam 232 that has been ejected by ejector 202). The reformer 203 may also be configured to increase calorific value of the fuel and/or steam.

The heat exchanger 204 may be configured to heat input fuel received from the burner 206. The heat exchanger 204 may also be configured to recirculate reducing gases received from the blower 205, the burner 206, and the condenser 207. This recirculation of reducing gases is able to achieve a higher energy fuel-rich steam stream prior to outputting and/or directing the steam stream to the reformer 203 via the SOFC stack 210.

The reformer 203 outputs hydrogen-rich gas (e.g., reformate stream produced from the external fuel 201 and/or the ejector 202 output) to the fuel cell stack 210 where the hydrogen is oxidized. Oxidation of the hydrogen produces electric energy and water. Anode off gas 230 exiting the fuel cell stack 210 is operably coupled to an ejector 202 and the superheater 209, as shown in FIG. 3.

A flow splitter 240 may be configured to divide a primary anode off gas stream 230P into a first portion (anode off gas 230) and a second portion (anode off gas slip stream 231). The flow splitter 240 routes the first portion (e.g., the anode off gas 230, also referred to as “recirculation gas”) to the ejector 202. The flow splitter 240 also routes the second portion (the anode off gas slip stream 231) to the superheater 209. The steam-driven ejector 202 causes the anode recirculation gas to be mixed with the input fuel 201 stream directed to the reformer 203 and the inlet of the fuel cell stack 210.

The superheater 209 receives the second portion of the anode off gas (the anode off gas slip stream 231), as shown in FIG. 3. The superheater 209 is configured to lower temperature of the slip stream 231 (typically to less than about 600° C.) before the slip stream 231 enters a boiler 208. The superheater 209 directs this cooler slip stream 233 (less than about 600° C.) to the boiler 208 that, in turn, generates a steam, at least a portion 234 of which is directed back to the superheater 209.

The superheater 209 then directs at least some of the portion 234 of the steam that is directed thereto from the boiler 208 out of the superheater 209 as a high pressure steam 232. The high pressure steam 232 is directed to the ejector 202 to directly drive the ejector 202. The high pressure steam 232 is also directed for reentry to an anode recirculation loop. The anode recirculation loop is defined in the system ranging components from the ejector 202 to the SOFC stack 210, to the splitter 240, and then subsequently back to the ejector 202 via line 230 and line 231, as shown in FIG. 3. Illustratively, the ejector 202 is driven by both the anode off gas 230 and the high pressure steam 232.

The boiler 208 is configured to direct at least a portion of the cooler slip stream received from the superheater 209 (i.e. a portion of the slip stream 231 that is not directed back to the superheater 209, shown as line 233 in FIG. 3) to a condenser 207, as shown in FIG. 3. The condenser 207 is configured to cause water in the cooler slip stream 233 to condense in a condenser sump pump 216. In some instances, the condenser 207 condenses the water and directs dried cool gas 235 into the burner 206, and subsequently to a heat exchanger 204. The burner 206 can then heat the dried cool gas 235 and direct it to the heat exchanger 204, and subsequently to the cathode side (e.g., a cathode, such as the cathode 181C described above and shown in FIG. 2A or GDL 24 of FIG. 1C) of the SOFC stack 210.

The condenser sump pump 216 is configured to pump liquid water to the boiler 208. Thereby, the condenser sump pump 216 provides a water supply internal to the system 200 and alleviates a need for an external water supply. The boiler 208 may include a control valve 236 configured to direct water back to the condenser sump pump 216 in response to the amount of water in the boiler 208 exceeding a certain amount.

In some embodiments, the blower 205 directs cool, fresh air to the condenser 207 or directly to the heat exchanger 204, as shown in FIG. 3. The cool, fresh air from the blower 205 that flows to the condenser 207 can be condensed therein and can then flow to the heat exchanger 204 via fluid line 237. The cool, fresh air may be in a range of about −50° C. to about 70° C., including any specific or range of temperature comprised therein. For example, in some embodiments, the cool, fresh air may be in a range of about −30° C. to about 50° C. In some embodiments, the cool, fresh air may be in a range of about −10° C. to about 30° C. In some embodiments, the cool, fresh air may be in a range of about 20° C.

The heat exchanger 204 can then direct the air received directly from the blower 205 and the condensed cool, fresh air from the condenser 207 to the SOFC stack 210. In some embodiments, excess gas from the condenser 207 is passed through a burner 206 to vent off exhaust gases. In some embodiments, the air from the blower 205 may supply oxygen to the cathode side (e.g., a cathode, such as the cathode 181C described above and shown in FIG. 2A or GDL 24 of FIG. 1C) of the SOFC stack 210.

The reversible solid oxide fuel cell system 200 described in FIG. 3 requires minimal changes to enable electrolysis mode rather than fuel cell mode. Therefore, the present reversible solid oxide fuel cell system 200 can easily and efficiently enable transition between electrolysis mode and fuel cell mode. In electrolysis mode, air is used to dilute the oxygen as it is evolved during hydrogen production.

Another embodiment of a reversible solid oxide fuel cell system 300 in accordance with the present disclosure is shown in FIG. 4. The reversible solid oxide fuel cell system 300 is substantially similar to the reversible solid oxide fuel cell system 200 shown in FIG. 3 and described above. Accordingly, similar reference numbers in the 300 series indicate features that are common between the reversible solid oxide fuel cell system 300 and the reversible solid oxide fuel cell system 200. The description of the reversible solid oxide fuel cell system 200 is incorporated by reference to apply to the reversible solid oxide fuel cell system 300, except in instances when it conflicts with the specific description and the drawings of the reversible solid oxide fuel cell system 300.

As illustrated in FIG. 4, a reversible solid oxide fuel cell system 300 according to a further aspect of the present disclosure includes a steam-driven ejector 302. The steam-driven ejector 302 continues to provide circulation of the reducing gases while extra steam 312 is injected downstream of the ejector 302 outlet and reformer 303 to act as a source of hydrogen during electrolysis. In the embodiment shown in FIG. 4, the stack 310 is shown as a solid oxide electrolyte cell (“SOEC”) stack 310.

In some embodiments, a flow splitter 311 is arranged downstream of the SOEC stack 310 and receives the anode off gas 330 therefrom, as shown in FIG. 4. The flow splitter 311 directs a first portion 311A of the anode off gas 330 to the heat exchanger 315. The flow splitter 311 also directs a second portion 311B (also referred to as a “reducing gas”) of the anode off gas 330 to the ejector 302.

Extra steam 312 is preheated in the heat exchanger 315 by the off gases (anode off gas 330) generated from the SOEC stack 310, which are rich in excess hydrogen. Specifically, the first portion 311A is mixed with the extra steam 312 in the heat exchanger 315 so as to heat up the steam 312 and produce a “steam mixture” that is directed to the hydrogen separator 313, as shown in FIG. 4. In some embodiments, the steam mixture may be referred to as a “first part” of the reducing gas and steam mixture. The steam mixture that is output from the heat exchanger 315 may pass through a water condensation unit (“WCU”) 313A arranged within the hydrogen separator 313. The hydrogen separator 313, which includes the water condensation unit 313A, then separates the water and hydrogen, leaving a pure hydrogen stream, as shown in FIG. 4.

In some embodiments, similar to the reversible solid oxide fuel cell system 200, the system 300 includes an additional splitter 340 configured to divide a primary anode off gas stream 330P into a first portion (anode off gas 330) and a second portion (anode off gas slip stream 331). The flow splitter 340 routes the first portion (the anode off gas 330, also referred to as “recirculation gas”) to the ejector 302 and routes the second portion (the anode off gas slip stream 331) to the superheater 309.

The superheater 309 provides the slip stream 331, which includes water, to boiler 308 and to the condenser 307 so as to provide energy to boil and superheat water that has been pumped up from the condenser 307 via the pump 316. Pumping the liquid water into the boiler 308 raises its pressure from atmospheric to a high pressure, and boiling expands that high pressure water. In some embodiments, the high pressure water is at a pressure of about 1 bar to 15 bar, including any specific or range of pressure comprised therein. For example, in some embodiments, the high pressure water is at a pressure of about 1 bar to 8 bar. In some embodiments, the high pressure water is at a pressure of about 3 bar to 13 bar. In some embodiments, the high pressure water is at a pressure of about 5 bar to 11 bar. In some embodiments, the high pressure water is at a pressure of about 7 bar to 9 bar. In some embodiments, the high pressure water is at a pressure of about 8 bar.

This high pressure steam 332 is then sent to the ejector 302 (via line 332 in FIG. 4) to drive the ejector 302. The second portion (anode off gas 330) is directed to the flow splitter 311, which then sends the reducing gas to the ejector 302 via line 311B. In some embodiments, the condenser 307 may send a “second part” of the hydrogen and steam mixture received from the boiler 308 to the hydrogen separator 313 via line 334.

In some embodiments, the heat exchanger 315 may pass the received hydrogen and extra steam 312 to a flow mixer 314. The flow mixer 314 receives the hydrogen and the extra steam 312, as well as hydrogen-rich gas from the reformer 303, and outputs these fluids to the cell stack 310. The heat exchanger 315 is also configured to pass the output from the flow splitter 311 and the extra steam 312 to the hydrogen separator 313 for separation of the water and hydrogen into the pure hydrogen steam.

The burner 306 is optional in embodiments such as the system 300 shown in FIG. 4. Specifically, the burner 306 may be more useful in an electrolysis mode of the SOEC stack 310 as opposed to a fuel cell mode of the SOEC stack 310.

Another embodiment of a reversible solid oxide fuel cell system 400 in accordance with the present disclosure is shown in FIG. 5. The reversible solid oxide fuel cell system 400 is substantially similar to the reversible solid oxide fuel cell systems 200, 300 shown in FIGS. 3 and 4 and described above. Accordingly, similar reference numbers in the 400 series indicate features that are common between the reversible solid oxide fuel cell systems 200, 300 and the reversible solid oxide fuel cell system 400. The descriptions of the reversible solid oxide fuel cell systems 200, 300 are incorporated by reference to apply to the reversible solid oxide fuel cell system 400, except in instances when they conflict with the specific description and the drawings of the reversible solid oxide fuel cell system 400.

As shown in FIG. 5, in the reversible fuel cell and electrolysis system 400, pure oxygen is generated as an output from the SOEC stack 410 rather than being diluted by air during recirculation via the blowers 205, 305 discussed above. Specifically, air does not drive the condenser 407 via a blower (e.g. blower 205, 305). Instead, hot gases exit the boiler 408 joining the cooled stream of hydrogen and water going into the hydrogen separator 413 via line 434. In some embodiments, the SOEC stack 410 may exhaust oxygen 450 to the heat exchangers 415, also referred to as “generated” oxygen herein.

In this reversible fuel cell and electrolysis system 400, heat from hot oxygen 450 is transferred to the extra steam 412 as the hot oxygen 450 passes through the multiple heat exchangers 415, as shown in FIG. 5. Illustratively, the heat exchangers 415 include two parallel heat exchangers 415. One heat exchanger 415 receives the steam mixture 411A and the extra steam 412 from the flow splitter 411 and the other heat exchangers 415 receives the hot oxygen 450 from the SOEC stack 410. In addition, heat from the anode off gas 430 also provides heat to the extra steam 412.

In some embodiments, the streams of oxygen 450 and hydrogen-steam mixture (411A and 412) may pass through the parallel heat exchangers 415 to maximize the heat recovery possible to the incoming steam. As shown in FIG. 5, the heat exchangers 415 may be configured to produce pure oxygen, while the hydrogen separator 413 is configured to produce pure hydrogen. Some of the hydrogen separator 413 output, which includes pure hydrogen and water, may be directed back to the condenser 407.

In some embodiments, the anode off gas 430 passes through a flow splitter 411 which splits the flow to the ejector 402 as reducing gas and to the heat exchanger 415 as a steam mixture. The heat exchanger 415 may then pass the received hydrogen and the extra steam 412 to a flow mixer 414, which receives the hydrogen and the extra steam 412 and hydrogen-rich gas from the reformer 403 and outputs these fluids to the cell stack 410. The heat exchanger 415 is also configured to pass the output from the flow splitter 411, the extra steam 412, and output from the cell stack 410 to the hydrogen separator 413.

The systems 200, 300, 400 and methods described herein optimize heat recovery while minimizing added components thereby enabling efficient operation of reversible fuel cells in both fuel cell and electrolysis modes. This novel approach reduces the investment and operational costs for reversible solid oxide fuel cell systems, which can generate electricity from hydrogen when electricity is needed, and generate hydrogen from electricity when electricity supply is in excess. Pre-existing approaches are not as efficient because they require steam to be preheated to temperatures higher than 500° C. in preparation for use during electrolysis.

The features illustrated or described in connection with one exemplary embodiment may be combined with any other feature or element of any other embodiment described herein. Such modifications and variations are intended to be included within the scope of the present disclosure. Further, a person skilled in the art will recognize that terms commonly known to those skilled in the art may be used interchangeably herein.

The above embodiments and aspects are described in sufficient detail to enable those skilled in the art to practice what is claimed and it is to be understood that other embodiments may be utilized and that logical, mechanical, and electrical changes may be made without departing from the spirit and scope of the claims. The detailed description is, therefore, not to be taken in a limiting sense.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values include, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first,” “second,” “third,” and the like, as used herein do not denote any order or importance, but rather are used to distinguish one element from another. The term “or” and “and/or” is meant to be inclusive and mean either, all, or any combination of the listed items. In addition, the terms “connected” and “coupled” are not restricted to physical or mechanical connections or couplings, and can include electrical connections or couplings, whether direct or indirect. Direct connection and/or coupling can include such connections and/or couplings where no intermittent connection or component is present between two endpoints, components, or items. Indirect connection and/or coupling can include where there is one or more intermittent or intervening connections and/or couplings present between respective endpoints, components, or items.

Moreover, unless explicitly stated to the contrary, embodiments “comprising,” “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps. The phrase “consisting of” or “consists of” refers to a compound, composition, formulation, or method that excludes the presence of any additional elements, components, or method steps.

The term “consisting of” also refers to a compound, composition, formulation, or method of the present disclosure that excludes the presence of any additional elements, components, or method steps. The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about and “substantially,” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description.

The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A method of circulating a reducing gas produced in a solid oxide fuel cell stack during electrolysis comprising:
providing steam to the solid oxide fuel cell stack as a source of heat or water;
splitting an exhaust gas from the solid oxide fuel cell stack into a first portion and a second portion, the first portion being directed to a superheater and the second portion being directed to a steam-driven ejector disposed downstream of the solid oxide fuel cell stack;
splitting the second portion of the exhaust gas into a reducing gas and a steam mixture;
directing the reducing gas to the steam-driven ejector and the steam mixture to a hydrogen separator including a water condensation unit; and
assisting water electrolysis by feeding externally supplied air to the solid oxide fuel cell stack to dilute oxygen,
wherein at least part of the first portion of the exhaust gas that is directed to the superheater is subsequently boiled in a boiler and then returned to the superheater, and, after being returned to the superheater, is directed to the steam-driven ejector as high pressure steam so as to drive the steam-driven ejector.

2. The method of claim 1, wherein the reducing gas is hydrogen.

3. The method of claim 1, wherein external steam is injected into the solid oxide fuel cell stack as a source of hydrogen.

4. The method of claim 3, wherein the solid oxide fuel cell stack is located downstream of an ejector outlet and a reformer.

5. The method of claim 2, wherein a first part of the hydrogen and the steam mixture is passed to the hydrogen separator and the water condensation unit to separate water and the hydrogen.

6. The method of claim 5, wherein at least a further part of the first portion of the exhaust gas that is directed to the superheater is directed to a condenser and is subsequently recycled to join the first part of the hydrogen and the steam mixture in the hydrogen separator.

7. The method of claim 6, wherein an excess gas from the condenser is passed through a burner to vent off exhaust gases.

8. The method of claim 2, wherein a portion of the hydrogen is directed from the solid oxide fuel cell stack to a superheater.

9. The method of claim 8, wherein the superheater is configured to produce the steam mixture form the portion of the hydrogen and direct the steam mixture to the steam driven ejector.

10. A method of generating pure oxygen and pure hydrogen in a solid oxide fuel cell stack during electrolysis comprising:
providing steam to the solid oxide fuel cell stack as a source of heat or water;
splitting an exhaust gas from the solid oxide fuel cell stack into a first portion and a second portion, the first portion being directed to a superheater and the second portion being directed to a steam-driven ejector disposed downstream of the solid oxide fuel cell stack;
splitting the second portion of the exhaust gas into a reducing gas and a steam mixture;
directing the reducing gas to the steam-driven ejector and the steam mixture to a hydrogen separator including a water condensation unit; and
feeding the steam mixture and oxygen generated by the solid oxide fuel cell stack to parallel heat exchangers to maximize heat recovery to external steam injected into the system,
wherein at least part of the first portion of the exhaust gas that is directed to the superheater is subsequently boiled in a boiler and then returned to the superheater, and, after being returned to the superheater, is directed to the steam-driven ejector as high pressure steam so as to drive the steam-driven ejector.

11. The method of claim 10, wherein the external steam is injected to the solid oxide fuel cell stack, downstream to an ejector outlet and a reformer as a source of hydrogen.

12. The method of claim 11, wherein a first part of the hydrogen and the steam mixture is passed to the hydrogen separator and the water condensation unit to separate water and the hydrogen.

13. The method of claim 12, wherein at least a further part of the first portion of the exhaust gas that is directed to the superheater is directed to a condenser and is subsequently recycled to join the first part of the hydrogen and the steam mixture in the hydrogen separator.

14. The method of claim 11, further comprising:
assisting water electrolysis by feeding externally supplied air to the solid oxide fuel cell stack to dilute oxygen.

15. A reversible solid oxide fuel cell system for use during electrolysis comprising:
a solid oxide fuel cell stack;
an ejector fluidly coupled to the fuel cell stack and configured to receive exhaust gas from the solid oxide fuel cell stack,
a first flow splitter configured to split the exhaust gas from the solid oxide fuel cell stack into a first portion and a second portion, the first portion being directed to a superheater and the second portion being directed to the ejector;
a second flow splitter arranged downstream of the first flow splitter and configured to split the second portion of the exhaust gas into a reducing gas and a steam mixture, the reducing gas being directed to the ejector;
a hydrogen separator including a water condensation unit arranged downstream from the ejector and configured to receive the steam mixture generated from the solid oxide fuel cell stack; and
two or more parallel heat exchangers arranged downstream of the ejector and configured to separately receive the steam mixture and oxygen generated by the solid oxide fuel cell stack to maximize heat recovery,
wherein at least part of the first portion of the exhaust gas that is directed to the superheater is subsequently boiled in a boiler and then returned to the superheater, and, after being returned to the superheater, is directed to the steam-driven ejector as high pressure steam so as to drive the steam-driven ejector.

16. The system of claim 15, wherein external steam is injected to the solid oxide fuel cell stack, downstream to an ejector outlet and a reformer as a source of hydrogen.

17. The system of claim 16, wherein a first part of the hydrogen and the steam mixture is passed to the hydrogen separator and the water condensation unit to separate a water and the hydrogen.

18. The system of claim 17, wherein at least a further part of the first portion of the exhaust gas that is directed to the superheater is directed to a condenser and is subsequently recycled to join the first part of the hydrogen and the steam mixture in the hydrogen separator.

19. The system of claim 16, assisting water electrolysis by feeding externally supplied air to the solid oxide fuel cell stack to dilute oxygen.

20. The system of claim 15, wherein the reducing gas is hydrogen.
